(19) United States
(12) Patent Application Publication
(10) Pub. No.: US 2026/0269631 A1
(43) Pub. Date: Sep. 10, 2026

(54) MICROGRID POWER MANAGEMENT SYSTEM AND METHOD FOR PROVIDING ANCILLARY SERVICE

(71) Applicants: Nanyang Technological University, Singapore (SG); LITE-ON SINGAPORE PTE. LTD., Singapore (SG)

(72) Inventors: Ziming Yan, Singapore (SG); Zhenyuan Du, Singapore (SG); Hongyi Chen, Singapore (SG); Yan Xu, Singapore (SG); Jing Yang, Singapore (SG); Jinlong Wang, Singapore (SG)

(21) Appl. No.: 19/410,848

(22) Filed: Dec. 5, 2025

Related U.S. Application Data
(60) Provisional application No. 63/768,245, filed on Mar. 7, 2025.

(51) Int. Cl. H02J 3/466; G06Q 30/0283; G06Q 50/06; H02J 3/00; H02J 3/32; H02J 101/24; H02J 103/35

(52) U.S. Cl. CPC H02J 3/466; G06Q 30/0283; H02J 3/32; G06Q 50/06; H02J 3/003; H02J 3/004; H02J 2101/24; H02J 2103/35

(57) ABSTRACT

A microgrid power management system configured to control a plurality of power resources to provide ancillary services to an electrical power system is provided. A resource preference generating unit generates priority parameters for the power resources according to time-varying cost-effectiveness values of the power resources and an accumulated deviation value. The accumulated deviation value is a sum of deviations between a target power setpoint and an actual power value over a time period. The target power setpoint is provided by the electrical power system. The actual power value includes a total power of the power resources. The adjustment command generating unit outputs a plurality of power control commands to the power resources according to the priority parameters for the power resources. The power resources adjust power delivered to the electrical power system or adjust power consumption from the electrical power system in response to the power control command.

This application claims the benefit of U.S. Provisional Application Ser. No. 63/768,245, filed Mar. 7, 2025, the disclosure of which is incorporated by reference herein in its entirety.

### TECHNICAL FIELD

The disclosure relates to a microgrid power management system and method configured to control power resources to provide ancillary services to an electrical power system.

### BACKGROUND

As the global energy landscape continues to evolve, microgrids have emerged as critical components in addressing localized energy demands, supporting grid stability, and facilitating the integration and management of distributed energy resources (DERs), such as photovoltaic (PV) systems and battery energy storage systems (BESS). Owing to their operational flexibility and proximity to end-users, microgrids are particularly well-suited to provide ancillary services, such as frequency regulation and voltage control, to utility grids. These ancillary services are essential for maintaining grid reliability, especially under conditions of increasing energy demand, the intermittency of renewable energy generation, and rapidly changing market dynamics.

Nevertheless, a need exists for a system that enables microgrids to deliver frequency regulation and voltage control services in a manner that is both more sustainable and economically efficient. Existing approaches mostly (i) track utility setpoints without accounting for battery degradation and inverter capabilities, leading to excessive cycling and curtailment, or (ii) prioritize economic dispatch without guarantees of real-time setpoints tracking under uncertainties. Developing such a system has become a focal point of research and development efforts within the energy industry.

### SUMMARY

According to one embodiment, a microgrid power management system configured to control a plurality of power resources to provide ancillary services to an electrical power system is provided. The microgrid power management system includes a resource preference generating unit and an adjustment command generating unit. The resource preference generating unit generates a plurality of priority parameters for the power resources based on a plurality of time-varying cost-effectiveness values (CEV, an effect-per-cost index) of the power resources and an accumulated deviation value. The accumulated deviation value is a sum of deviations between a target power setpoint and an actual power value over a time period. The target power setpoint is provided by the electrical power system. The actual power value includes a total power of the power resources. The adjustment command generating unit outputs a plurality of power control commands to the power resources according to the priority parameters for the power resources. At least one of the power resources adjusts power delivered to the electrical power system or at least one of the power resources adjusts power consumption from the electrical power system in response to at least one corresponding power control command.

According to another embodiment, a microgrid power management method for controlling a plurality of power resources to provide ancillary services to an electrical power system is provided. The microgrid power management method includes the following steps. A plurality of priority parameters for the power resources are generated based on a plurality of time-varying cost-effectiveness values of the power resources and an accumulated deviation value. The accumulated deviation value is a sum of deviations between a target power setpoint and an actual power value over a time period. The target power setpoint is provided by the electrical power system. The actual power value comprises a total power of the power resources. A plurality of power control commands are outputted to the power resources according to the priority parameters of the power resources. At least one of the power resources adjusts power delivered to the electrical power system or at least one of the power resources adjusts power consumption from the electrical power system in response to at least one corresponding power control command.

### BRIEF DESCRIPTION OF THE DRAWINGS

FIG. 1 shows the block diagram of a microgrid power management system configured to control power resources to provide ancillary services to a utility grid according to an embodiment of the disclosure.

FIG. 2 shows the schematic diagram of a microgrid controlled by the microgrid power management system of FIG. 1.

FIG. 3 shows the block diagram of a microgrid power management system configured to control power resources to provide ancillary services to a utility grid according to another embodiment of the disclosure.

FIG. 4 shows the control architecture of the microgrid power management system which is designed as a hierarchical framework.

FIG. 5A to FIG. 5C show an example for microgrid power control results including microgrid power adjustment, power deviations, and power output compositions for each power resource.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

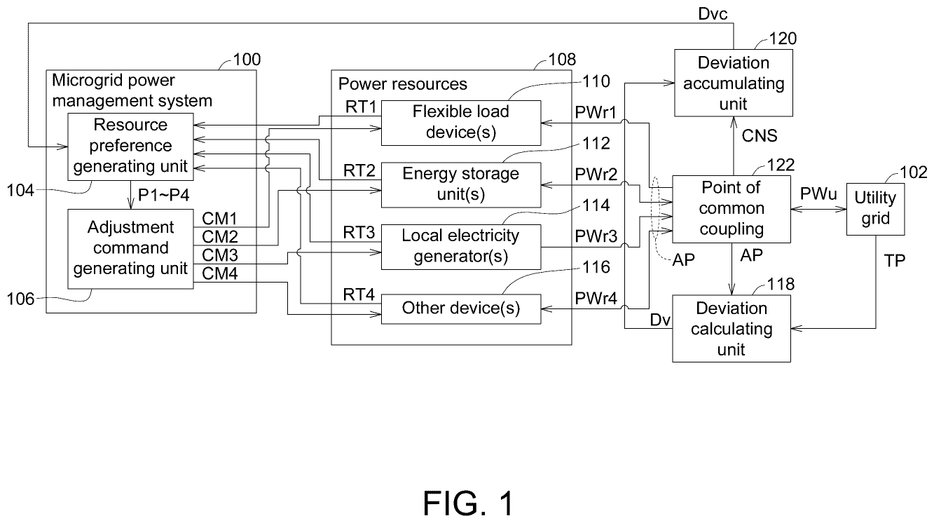

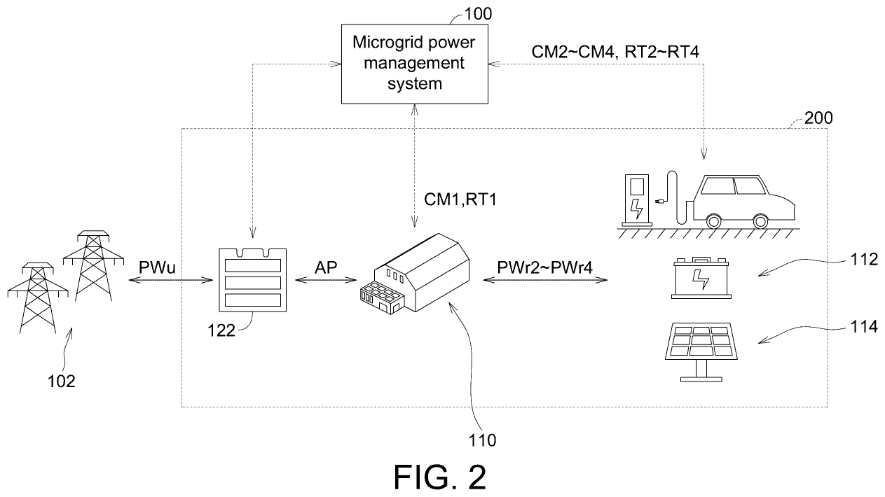

Referring to FIG. 1 and FIG. 2, FIG. 1 shows the block diagram of a microgrid power management system configured to control power resources to provide ancillary services to an electrical power system according to an embodiment of the disclosure, and FIG. 2 shows the schematic diagram of a microgrid controlled by the microgrid power management system of FIG. 1. A microgrid power management system 100 is configured to control power resources 108 to provide ancillary services to an electrical power system, for example a utility grid 102. The microgrid power management system 100 includes a resource preference generating unit 104 and an adjustment command generating unit 106. The resource preference generating unit 104 generates a plurality of priority parameters P1 to P4 for the power resources 108 based on time-varying cost-effectiveness values of the power resources 108, and an accumulated deviation value Dvc. The accumulated deviation value Dvc is a sum of deviations Dv between a target power setpoint TP and an actual power value AP over a time period. The target power setpoint TP is provided by the utility grid 102. The actual power value AP includes a total power of the power resources 108. The adjustment command generating unit 106 outputs a plurality of power control commands CM1 to CM4 to the power resources 108 according to the priority parameters P1 to P4 of the power resources 108. At least one of the power resources 108 adjusts power delivered by local generation and storage to the utility grid 102, or at least one of the power resources 108 adjusts power consumption by local flexible load from the utility grid 102 in response to at least one corresponding power control command CM1 to CM4. The term “electric power system” refers to any system for generating, transmitting, distributing, or consuming electrical energy, including but not limited to a utility grid, a microgrid, an off-grid system, or a distributed energy network. In this embodiment, the utility grid will be taken as an example for the electric power system. The microgrid power management system 100 will be described in more detail as follows.

Referring to FIG. 1 and FIG. 2, when the utility grid 102 experiences a frequency deviation from the rated frequency, or a voltage deviation from the rated voltage, the utility grid 102 may request the microgrid 200 to provide ancillary services to the utility grid 102. The utility grid 102 will provide the target power setpoint TP which is proportional to the frequency deviation or the voltage deviation to the microgrid power management system 100. The target power setpoint TP is the power which the utility grid 102 requests the microgrid 200 to provide or to consume. Through the ancillary services, the microgrid 200 delivers power to the utility grid 102 or consumes power from the utility grid 102, and provides frequency regulation service and voltage control service for the utility grid 102. With the power provided by the microgrid 200 or consumed by the microgrid 200, the frequency deviation from the rated frequency or the voltage deviation from the rated voltage will be reduced, and the stability and efficiency of utility grid 102 will be improved.

In some embodiment, the microgrid power management system 100 further includes a deviation calculating unit 118 and a deviation accumulating unit 120. When the utility grid 102 experiences a frequency deviation from the rated frequency or a voltage deviation from the rated voltage, the utility grid 102 will output an automatic generation control (AGC) signal including the target power setpoint TP to the deviation calculating unit 118. The deviation calculating unit 118 outputs the deviation value Dv which is a deviation between the target power setpoint TP and the actual power value AP. The deviation accumulating unit 120 outputs the accumulated deviation value Dvc, which is the accumulated summation of the deviation values Dv over a particular time period. The actual power value AP includes a total power of the power resources 108. The usage of the accumulated deviation value Dvc can mitigate the imbalance between the target power setpoint TP and the actual power AP under uncertainties, and suppresses rapid fluctuation phenomenon which happens in the deviation values Dv.

In some embodiment, the actual power value is the aggregate power of the power resources at point of common coupling. In some embodiment, the actual power value is the net power of the microgrid, defined as the aggregate generation of the power resources minus the aggregate load. A controller, in accordance with priority parameters for the power resources, generates and issues a plurality of power control commands to respective power resources. Responsive to a respective command, at least one power resource adjusts its exported power to the utility grid and/or its imported power from the utility grid.

In some embodiment, the power resources 108 include flexible load device(s) 110, energy storage unit(s) 112, local electricity generator(s) 114, and other device(s) 116. The flexible load device(s) 110 adjust(s) power consumption from the utility grid 102 in response to the power control command CM1 of the flexible load device(s) 110. That is, the flexible load device(s) 110 regulate(s) the amount of power drawn from the utility grid 102 in response to the power control command CM1 of the flexible load device(s) 110. Besides, the energy storage unit(s) 112 and the local electricity generator(s) 114 adjust power delivered to the utility grid 102 in response to the power control command CM2 and CM3. The actual power value AP includes the total power of the power PWr1 of the flexible load device(s) 110 (the power PWr1 received or consumed by the flexible load device(s) 110), the power PWr2 of the energy storage unit(s) 112 (the power PWr2 received or outputted by the energy storage unit(s) 112), the power PWr3 of the local electricity generator(s) 114 (the power PWr3 outputted by the local electricity generator(s) 114), and the power PWr4 of the other device(s) 116 (the power PWr4 consumed or outputted by the other device(s) 116).

The resource preference generating unit 104 determines the priority parameters P1 to P4 of the power resources 108 according to a plurality of time-varying cost-effectiveness values of the respective power resources 108 and an accumulated deviation value Dvc, as described below. For each resource, a cost-effectiveness value (CEV) denotes an effect-per-cost index, which is computed as incremental power provided by respective power resources 108 divided by incremental cost of providing the power. The incremental cost includes monetary cost for power, device degradation costs, comfort penalty, or production-loss surrogate per kW. Incremental cost-effectiveness will become 0 when storage units are exhausted or maximum device power is reached. Regarding the flexible load device(s) 110 of the power resources 108, the flexible load device(s) 110 can be the load device(s) in a residential house or a factory, for example. The load device(s) in a residential house may include household appliances, for example, industrial chillers, cold-chain warehouses, household washing machine, and so on. The total load in the microgrid is changeable and flexible since these appliances can be turned on or turned off. If these microgrid appliances can be turned on and turned off at any time, the time-varying cost-effectiveness values of these household appliances will be determined with a higher level. If some microgrid appliance cannot be turned off during a particular time period, the cost-effectiveness value of this household appliance will be determined to a lower level during this particular time period. Low cost-effectiveness value will result in low priority parameters of using its resources. For example, assume the air conditioner cannot be turned off in the afternoon during summer. Then, the time-varying cost-effectiveness value of the air conditioner during the afternoon is determined as 0, corresponding to a low resource priority. Regarding the load device(s) in the factory, the load device(s) in the factory can be a production line. If the production line in the factory cannot be interrupted during a certain time period, the time-varying cost-effectiveness value of the production line during the certain time period is determined as 0. In some embodiment, each load device can have its own cost-effectiveness value. Or, total load devices in one building (house or factory) can have one cost-effectiveness value.

Regarding the energy storage unit(s) 112 of the power resources 108, the energy storage unit(s) 112 can be batteries or the battery in an electric vehicle. For discharging, when the state of charge (SoC) of the batteries is high, the marginal cost of discharging due to degradation and per kW power in the batteries is low, and the time-varying cost-effectiveness value of the batteries can be determined to a higher level. Conversely, when the SoC of the batteries is low, the cost for discharging in the batteries is high, and the time-varying cost-effectiveness value of the batteries can be set to a lower level. As used herein, SoC denotes the ratio of the present charge to the battery's maximum capacity; 100% SoC indicates fully charged and 0% SoC indicates fully discharged. SoC is an indicator for understanding how much energy is left in the battery.

Regarding the local electricity generator(s) 114 of the power resources 108, the local electricity generator(s) 114 can include photovoltaic generators and diesel generators, for example. When there is abundant sunlight, the electricity generation cost of a photovoltaic generator is low, and the time-varying cost-effectiveness value of the photovoltaic generator can be determined a high value. When there is insufficient sunlight, the photovoltaic generator cannot generate electricity, and the time-varying cost-effectiveness value of the photovoltaic generator during this period is near 0 due to non-incremental power. For a diesel generator, it typically has quadratic costs of generation with respect to power. When the price of diesel increases, the unit cost of generation is higher and the time-varying cost-effectiveness value is lower; conversely, when fuel prices decrease, the cost-effectiveness value is higher.

The resource preference generating unit 104 assigns higher priority to the power resources 108 having higher time-varying cost-effectiveness values and generates the priority parameters P1-P4 accordingly. The accumulated deviations Dvc will guide the direction of increasing or decreasing net power output. The command of increasing or decreasing power checks and time-varying cost-effectiveness values of resources are input in the logic of resources preference generating unit 104. If constraints of one or more resources are reached, the remaining power output gap will be allocated to other resources based on the cost-effectiveness values. For example, when sunlight is strong (e.g., from 1:00 PM to 3:00 PM), the cost-effectiveness of the photovoltaic generator increases, and the resource preference generating unit 104 assigns a higher-valued priority parameter P3 to the photovoltaic generator. For example, when the state of charge of the battery is low, the battery's cost-effectiveness decreases, and the resource preference generating unit 104 assigns a lower-valued priority parameter P2 to the battery, and other resources will be preferred over battery until their maximum power constraints are reached.

Then, the adjustment command generating unit 106 generates the power control commands CM1 to CM4 for the power resources 108 according to the priority parameters P1 to P4 of the power resources 108. The requested ancillary service direction will affect accumulated deviations Dvc and calls for up-regulation command to increase net power delivered to the utility grid 102, or down-regulation to decrease net power delivered by utility grid 102 or decrease the absorbed power by utility grid 102. The cost-effectiveness values, capacity and constraints of resources are integrated in the priority parameters for preference allocation. Related to the priority parameter with higher values, the power control command will be the command to instruct the corresponding power resource to provide more power to the utility grid 102. For example, when the priority parameter P1 for the flexible load device(s) 110 has higher value, the power control command CM1 for flexible load device(s) 110 will be the command to instruct the flexible load device(s) 110 to consume more power received from the utility grid 102. When the state of charge of the energy storage unit(s) 112 (for example, the battery) is high, the priority parameter P2 for the energy storage unit(s) 112 has higher value, and the power control command CM2 for the energy storage unit(s) 112 will be the command to instruct the energy storage unit(s) 112 to provide more power to the utility grid 102. Besides, when the sunlight is strong during 1 PM to 3 PM, the priority parameter P3 for the photovoltaic generator of the local electricity generator(s) 114 has higher value, and the power control command CM3 for the photovoltaic generator of the local electricity generator(s) 114 will be the command to instruct the photovoltaic generator of the local electricity generator(s) 114 to provide more power to the utility grid 102.

Therefore, at least one of the power resources 108 (at least one of the energy storage unit(s) 112, local electricity generator(s) 114, and other device(s) 116) adjusts power delivered to the utility grid 102 in response to at least one corresponding power control command CM2 to CM4. Or, at least one of the power resources 108 (the flexible load device(s) 110) adjusts power consumption from the utility grid 102 in response to at least one corresponding power control command CM1. That is, at least one of the power resources 108 (at least one of the energy storage unit(s) 112, local electricity generator(s) 114, and other device(s) 116) increase or decrease the power delivered to the utility grid 102 through the point of common coupling 122. Or, at least one of the power resources 108 (the flexible load device(s) 110) adjusts power received from the utility grid 102 via the point of common coupling 122.

As mentioned above, the actual power value AP includes the total power of the power resources 108, that is, the total power of the power PWr1 of the flexible load device(s) 110, the power PWr2 of the energy storage unit(s) 112, the power PWr3 of the local electricity generator(s) 114, and the power PWr4 of the other device(s) 116. When the utility grid 102 encounters the frequency deviation from the rated frequency or the voltage deviation from the rated voltage, the microgrid 200 provides the ancillary services (frequency regulation service or voltage control service) to the utility grid 102 under the control of the microgrid power management system 100 by adjusting the actual power value AP delivered to the utility grid 102. For example, when the frequency of the utility grid 102 is lower than the rated frequency, the utility grid 102 outputs a corresponding higher target power setpoint TP, and the actual power value AP is increased, so that the power resources 108 increase the power (especially active power) delivered to the utility grid 102. Then, the frequency of the utility grid 102 will be increased and the problem of the frequency deviation in the utility grid 102 is resolved. When the frequency of the utility grid 102 is higher than the rated frequency, the utility grid 102 outputs a corresponding lower target power setpoint TP, and the actual power value AP is reduced, even to be negative, so that the power resources 108 decrease the power delivered to the utility grid 102 or the power resources 108 consume more power delivered from the utility grid 102. Then, the frequency of the utility grid 102 will be decreased and the problem of the frequency deviation in the utility grid 102 is resolved.

Besides, when the voltage of the utility grid is lower than the rated voltage, the utility grid 102 outputs a corresponding higher target power setpoint TP, and the actual power value AP is increased, so that the power resources 108 increase the power (especially reactive power) delivered to the utility grid 102. Then, the voltage of the utility grid 102 will be increased and the problem of the voltage deviation in the utility grid 102 is resolved. When the voltage of the utility grid 102 is higher than the rated voltage, the utility grid 102 outputs a corresponding lower target power setpoint TP, and the actual power value AP is reduced, even to be negative, so that the power resources 108 decrease the power delivered to the utility grid 102 or the power resources 108 consume more power delivered from the utility grid 102. Then, the voltage of the utility grid 102 will be decreased and the problem of the voltage deviation in the utility grid 102 is resolved.

For example, assume the target power setpoint TP is 1000 kW (which means the power adjustment in the mount delivered to the utility grid 102 should be 1000 kW), the resource preference generating unit 104 assigns signed priority parameters P1 to P3 of the power resources 108 as −0.2, 0.6, 0.2. The priority parameters P1 to P3 can be used as weights to calculating the power PWr1 of the flexible load device(s) 110, the power PWr2 of the energy storage unit(s) 112, and the power PWr3 of the local electricity generator(s) 114 to obtain that the power adjustment PWr1 equals to 1000 kW multiplied by (−0.2), that is (−200) kW; the power PWr2 equals to 1000 kW multiplied by 0.6, that is 600 kW; the power PWr3 equals to 1000 kW multiplied by 0.2, that is 200 kW. This means that the flexible load device(s) 110 should reduce the power consumption by an amount of 200 kW, the energy storage unit(s) 112 should increase the power delivered to the utility grid 102 by an amount of 600 kW, and the local electricity generator(s) 114 should increase the power delivered to the utility grid 102 by an amount of 200 kW. Then, the actual power value AP will be the sum of increased delivering power to the utility grid 102 (PWr2+PWr3) minus the reduced power consumption (PWr1), equal to PWr2+PWr3−PWr1, which is 600+200−(−200) kW, that is 1000 kW.

In some embodiment, the real-time data RT1 to RT4 of the power resources 108 is inputted to the resource preference generating unit 104. The priority parameters P1 to P4 of the power resources are generated according to the time-varying cost-effectiveness values of the power resources 108 and the accumulated deviation value Dvc, and further according to the constraints for the power resources 108 and the real-time data RT1 to RT4 of the power resources 108. Feedback control mechanism is performed to minimize deviations between the target power setpoint TP and the actual power value AP. For example, the point of common coupling 122, the deviation calculation unit 118, the deviation accumulating unit 120, the resource preference generating unit 104, the adjustment command generating unit 106, the power resources 108, and the point of common coupling 122 form a closed loop to perform feedback control mechanism. With this feedback control mechanism, the actual power value AP is adjusted to reduce the deviation between the actual power value AP and the target power setpoint TP and minimize the deviation between the actual power value AP and the target power setpoint TP, so that the actual power value AP will follow the target power setpoint TP, even when measurement for local devices are incorrect or there are uncertainties of photovoltaic fluctuations.

In some embodiment, the time-varying cost-effectiveness values of the power resources 108 are determined according to unit power per cost of the power resources 108. The unit power per cost of the power resources 108 may be determined according to electricity cost and wearing cost of the power resources 108. The unit power per cost of the power resources 108 means the power generated by power resources per cost for the power resources 108, for example, CEV 1 kW/$ denotes 1 kW power can be generated by resources with associated costs equal to $1. The electricity cost means the cost to generate electricity for unit power, and the wearing cost refers to the cost or price corresponding to the loss caused by the equipment of the power resources 108 during the power generation process.

In some embodiment, the resource preference generating unit 104 is implemented as a dynamic unit configured to generate, in real time, a plurality of priority parameters P1-P4 for the power resources 108. Because the unit operates dynamically and responds in real time to conditions of the utility grid 102, the microgrid 200 can provide ancillary services (e.g., frequency regulation and voltage control) with low latency, thereby reducing frequency and/or voltage deviations and facilitating restoration toward nominal values as soon as possible.

In some embodiment, the resource preference generating unit 104 generates the priority parameters P1 to P4 of the power resources 108 according to the time-varying cost-effectiveness values of the power resources 108 and the accumulated deviation value Dvc, and further according to constraints of the power resources. The constraints of the power resources, for example, include at least one of maximum output, ramp rate, state of charge (SoC) limitations for the power resources 108 being energy storage unit(s). For example, when the energy storage unit(s) 112 has reached minimum state of charge (SoC) limitation, for example, 0% SoC, the energy storage unit(s) 112 cannot provide any more electricity and the resource preference generating unit 104 will set the priority parameters P2 of the energy storage unit(s) 112 to be minimum value.

In some embodiment, the point of common coupling 122 may output constraint boundary values CNS to the deviation accumulating unit 120. The constraint boundary values CNS may be used to limit the value of the accumulated deviation value Dvc.

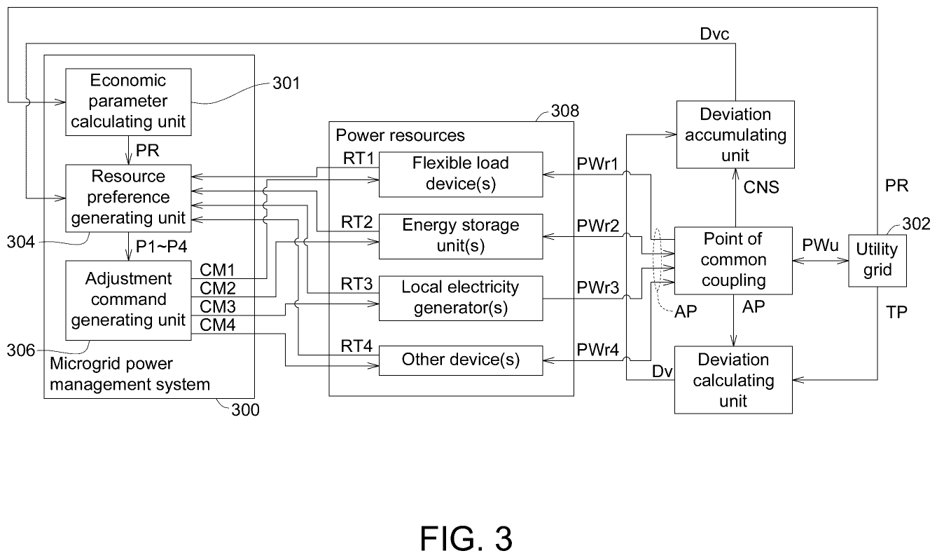

Referring to FIG. 3, FIG. 3 shows the block diagram of a microgrid power management system configured to control power resources to provide ancillary services to a utility grid according to another embodiment of the disclosure. The difference between FIG. 3 and FIG. 1 relies in that the microgrid power management system 300 of FIG. 3 further includes an economic parameter calculating unit 301. The economic parameter calculating unit 301 received a price offer value PR from the utility grid 302 and outputting the price offer value PR to the resource preference generating unit 304. The resource preference generating unit 304 generates the priority parameters P1 to P4 of the power resources 308 according to the time-varying cost-effectiveness values of the power resources 308, the accumulated deviation value Dvc, and the price offer value PR. The adjustment command generating unit 306 outputs a number of power control commands CM1 to CM4 to the power resources 308 according to the priority parameters P1 to P4 of the power resources 308.

The price offer value PR refers to the amount that utility grid 302 will pay after the microgrid 200 provides the requested target power setpoint TP. The resource preference generating unit 304 will allocate suitable resources in power resources 308 to generate electricity or consume power to ensure that the microgrid 200 can gain some profit. Therefore, the resource preference generating unit 304 will generates the priority parameters P1 to P4 of the power resources 308 through considering the price offer value PR, except considering the time-varying cost-effectiveness values of the power resources 308 and the accumulated deviation value Dvc.

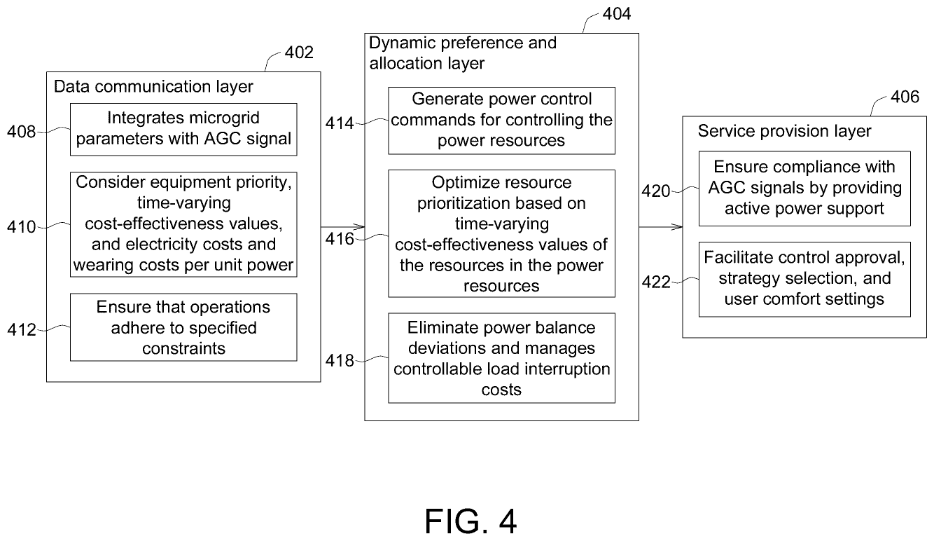

One example will be provided below to more clearly illustrate the present disclosure. Referring to FIG. 4, FIG. 4 shows the control architecture of the microgrid power management system which is designed as a hierarchical framework. The process for the microgrid power management system to perform control operations includes three layers, for example, a data communication layer 402, a dynamic preference and allocation layer 404, and service provision layer 406. In the data communication layer 402, step 408 to step 412 are performed. In step 408, the microgrid power management system integrates microgrid parameters with AGC signal. In step 410, the microgrid power management system considers equipment priority, time-varying cost-effectiveness values, and electricity costs and wearing costs per unit power. In step 412, the microgrid power management system ensures that operations adhere to specified constraints.

In the dynamic preference and allocation layer 404, step 414 to step 418 are performed. In step 414, the microgrid power management system generates power control commands for controlling the power resources. In step 416, the microgrid power management system optimizes resource prioritization based on time-varying cost-effectiveness values of the resources in the power resources. In step 418, the microgrid power management system eliminates power balance deviations and manages controllable load interruption costs.

In the service provision layer 406, step 420 and step 422 are performed. In step 420, the microgrid power management system ensures compliance with AGC signals by providing active power support. In step 422, the microgrid power management system facilitates control approval, strategy selection, and user comfort (not interrupting key devices) settings.

As shown in FIG. 4, the control architecture of the microgrid power management system includes three layers, for ensuring the ancillary services with the AGC signal, stability of utility grid, and optimal power resource utilization. The data communication layer 402 focuses on real-time regulation in the outputs of distributed energy resource (DER) or power resources to meet requirements of utility grid, such as frequency stabilization or frequency regulation and voltage control. The data communication layer 402 uses a hierarchical-errors-accumulation controlling mechanism to dynamically adjust total power of the power resources and control the operations of the power resources dynamically, responding to immediate fluctuations in signals outputted from utility grid, including AGC signal. The data communication layer 402 serves as a first line of defensing against load deviations in the utility grid and ensures that the power resources can rapidly response to maintain the balance in the utility grid.

Building upon the data communication layer 402, the dynamic preference and allocation layer 404 operates at a slightly longer timescale, providing fine adjustments to setpoints of the power resources based on real-time optimization and predictive analytics. The dynamic preference and allocation layer 404 incorporates constraints, such as ramp rates, generation limits, and battery states of charge to ensure that operational decisions align with system goals. By integrating forecasts for demand, renewable generation, and market prices, the dynamic preference and allocation layer 404 enables the microgrid power management system to anticipate and respond proactively to dynamic changes in the utility grid and market. The dynamic preference and allocation layer 404 plays a pivotal role in determining time-varying cost-effectiveness while adhering to reliability standards.

$${De}_{t}^{load} = max ( {\sum }_{i}^{N} {P}_{t , i}^{load} - {\sum }_{i}^{N} {P}_{t , i}^{gen} - λ {L}_{max , c} , 0 ) \qquad ( 1 )$$

$${De}_{t}^{supply} = max ( - {\sum }_{i}^{N} {P}_{t , i}^{load} + {\sum }_{i}^{N} {P}_{t , i}^{gen} - μ {G}_{max , c} , 0 ) - Δ {P}_{c , AGC} \qquad ( 2 )$$

$$Δ {De}_{t}^{total} = {De}_{t}^{load} - {De}_{t}^{supply} \qquad ( 3 )$$

$${E}_{t + 1}^{accu} = {E}_{t}^{accu} + Δ {De}_{t}^{total} {T}_{s} \qquad ( 4 )$$

$${P}_{t}^{target} = {K}_{p} Δ {De}_{t}^{total} + {K}_{i} {E}_{t}^{accu} \qquad ( 5 )$$

$${De}_{t}^{load}$$

represents the load demand deviation at time t, which quantifies the exceeding of net load demand (total demand minus total supply) over constraints such as maximum allowable load.

$${P}_{t , i}^{load} and {P}_{t , i}^{gen}$$

represent the power demand and total power generation of the i-th load and generation at time t. λ and γ presents a security margin coefficient set to avoid violating net load constraints. L_{max,c} represents the maximum allowable load. The ΔP_{c,AGC} represents the AGC command of the utility grid 102.

$${De}_{t}^{supply}$$

represents the supply deviation over the total allowed net generation G_{max,c}, adjusted for system constraints such as penalties, minimal load, and maximum generation capacity. The Kᵢ represents a gain parameter in the control mechanism, which can be compensated by the rate of change of action for anti-windup compensation.

$${E}_{t}^{accu}$$

is the accumulated error or deviation at the current time step t.

$$Δ {De}_{t}^{total}$$

is the total power deviation at the current time step. Ts is the adjustment time step duration.

The service provision layer 406 addresses economic dispatch and long-term operational planning. The service provision layer 406 integrates market participation strategies, including bidding into ancillary service markets and optimizing the use of grid-tied and local power resources. The service provision layer 406 employs predictive analytics to develop schedules for power resources that minimize costs and maximize revenue while maintaining the reliability and stability of microgrid operations. The service provision layer 406 bridges the gap between technical operation and economic optimization, ensuring the financial viability of the microgrid power management system.

The microgrid power management system dynamically prioritizes distributed power resources based on availability and constraints. The power for i-th generation unit (for example, one equipment in local electricity generator(s) 114 of the power resources 108) is dependent on total target power

$${P}_{t , i}^{target}$$

(for example, related to target power setpoint TP) and the usage priority

$${p}_{t , i}^{gen}$$

(for example, related to priority parameters P1 to P4) of this generation unit before the generation unit reaches the maximum power

$${G}_{max , i}^{g e n}$$

of this generation unit. The power usage for i-th flexible load unit (for example, one equipment in flexible load device(s) of the power resources 108) is changed based on total target power

$${P}_{t , i}^{t a r g e t}$$

and the usage priority

$${p}_{t , i}^{flex}$$

of this load unit before this load unit reaches the maximum adjustable power

$${P}_{max , i}^{flex}$$

of this load unit.

$${G}_{t , i}^{gen} = min ( {P}_{t , i}^{t a r g e t} , {p}_{t , i}^{gen} , {G}_{max , i}^{g e n} ) \qquad ( 6 )$$

$${G}_{t , i}^{flex} = min ( {P}_{t , i}^{t a r g e t} , {p}_{t , i}^{flex} , {P}_{max , i}^{flex} ) \qquad ( 7 )$$

$${G}_{batt , i} = min ( {P}_{target} {p}_{batt , i} , {G}_{batt , i , max} ) \qquad ( 8 )$$

$${G}_{batt , i , max} = {P}_{rated , i} if {SoC}_{batt , i} > {SoC}_{i , min} else 0 \qquad ( 9 )$$

$${G}_{flex , i} = min ( {P}_{target} {p}_{flex , i} , {G}_{flex , i , max} ) \qquad ( 10 )$$

$${SoC}_{batt , i , t + 1} = {SoC}_{batt , i , t} - \frac{{G}_{batt , i} {T}_{s}}{{η}_{batt , i} {C}_{batt , i}} \qquad ( 11 )$$

$${G}_{t , i}^{g e n}$$

means actual power generated by the i-th generation unit at time t under given priority

$${p}_{t , i}^{g e n}$$

and target total power

$${P}_{t , i}^{t a r g e t}$$

at time t.

$${G}_{t , i}^{flex}$$

means actual power provided by the i-th flexible load unit at time t. G_{batt,i} means actual power provided by the i-th battery at time t, which is dependent on the remaining battery SoC. SOC_{batt,i,t} is the state-of-charge of the i-th battery at time t. η_{batt,i} denotes the charging/discharging efficiency and C_{batt,i} denotes the battery capacity.

The feedback control mechanism ties the three layers together to enable continuous system optimization. Real-time data streams, including load measurements, DER status, and market signals, feed into the control architecture, providing a closed-loop system for adaptive decision-making. The feedback control employs error signals derived from deviations in load, generation, or grid conditions to recalibrate control actions dynamically. By iteratively refining operational parameters at each layer, the feedback control ensures that the system maintains stability, adapts to changing conditions, and meets user-defined performance metrics.

Dynamic resource prioritization is at the heart of the ability of the microgrid power management system to optimize the utilization of distributed energy resources (DERs) under varying conditions. This mechanism evaluates and ranks resources such as photovoltaic (PV) units and battery energy storage systems (BESS), and controllable loads based on real-time availability, operational flexibility, and economic cost. By considering these factors, the microgrid power management system determines the optimal allocation of resources to maintain stability of utility grid while minimizing operational costs. For instance, PV units are prioritized during peak sunlight hours to maximize renewable energy utilization, while BESS is employed to provide backup power during low PV output or high-demand periods.

$${C}_{t}^{total} = {{\sum }_{i}}^{N} {c}_{I}^{res} + {C}_{t}^{pen} \qquad ( 12 )$$

$${R}_{t}^{total} = {R}_{t}^{reserve} + {R}_{t}^{regulation} - {C}_{t}^{total} \qquad ( 13 )$$

$$min \vert {P}_{t}^{target} - {{\sum }_{i}}^{N} {P}_{t , i}^{t a r g e t} {p}_{t , i}^{device} \vert \qquad ( 14 )$$

$$max {\sum }_{t} {R}_{t}^{total} \qquad ( 15 )$$

$${C}_{t}^{total}$$

is the total cost of providing the ancillary service at time t.

$${Σ}_{i}^{N} {c}_{I}^{res}$$

denotes the total resource costs across all resources at time t.

$${C}_{t}^{p e n}$$

is the penalty cost incurred due to constraints violation or contract failing at time t.

$${R}_{t}^{total}$$

is the total revenue at time t, considering the revenue from reserve services and revenue from regulation services. The equation (14) sets objective of the optimization to minimize the absolute power deviation, which ensures total dispatch of the power resources closely matches the overall target power output. Correspondingly, the priority of the individual power resources will generally follow a sequence by unit cost of power, i.e., cheap power supply will be consumed and then followed by expensive power.

The microgrid power management system leverages time-varying cost-effectiveness-values-based resources prioritization model to balance cost, comfort, and reliability. The objective function minimizes the total cost of operation while accounting for penalties associated with user-defined comfort levels and ancillary service reliability. During periods of high electricity prices, the time-varying cost-effectiveness mechanism may prioritize resources with lower operating costs, such as local generation and battery, over grid electricity. Similarly, user-defined comfort thresholds are integrated into the prioritization model to ensure that critical loads, such as heating or critical infrastructure, are not disrupted even during high-demand scenarios.

Each power resource is evaluated based on the operational constraints thereof and the contribution to overall system performance. Constraints such as maximum power output, state of charge for BESS, and ramp rates are factored into the prioritization process to prevent overutilization or instability. By dynamically updating these constraints in real time, the microgrid power management system ensures that power resources operate within safe and efficient boundaries. For instance, BESS charging and discharging cycles are managed to avoid deep discharges that could reduce battery lifespan, while ensuring sufficient capacity for frequency regulation.

To enable seamless prioritization, the microgrid power management system could further incorporate advanced forecasting techniques and real-time data streams. Forecasts of energy demand, renewable generation, and electricity market prices are integrated into the optimization model to anticipate future conditions. This allows the microgrid power management system to proactively allocate resources to meet anticipated demands, reducing the need for reactive adjustments. For example, the system may schedule BESS charging during periods of low electricity prices to ensure sufficient stored energy for peak demand hours, thereby optimizing both cost and resource utilization.

The microgrid power management system incorporates predictive analytics to anticipate future energy demand, resource availability, and market prices. This capability enables proactive scheduling of operations of the power resources, minimizing reliance on reactive adjustments. Stability is a critical design focus. To mitigate instability caused by accumulated error or integration drift, the system incorporates gain scheduling and anti-windup compensation. Gain scheduling refers to dynamically adjusting gains of controller and adjusting based on real-time system conditions. In anti-windup compensation, an anti-windup gain is used and the saturation limit of the control signal is used.

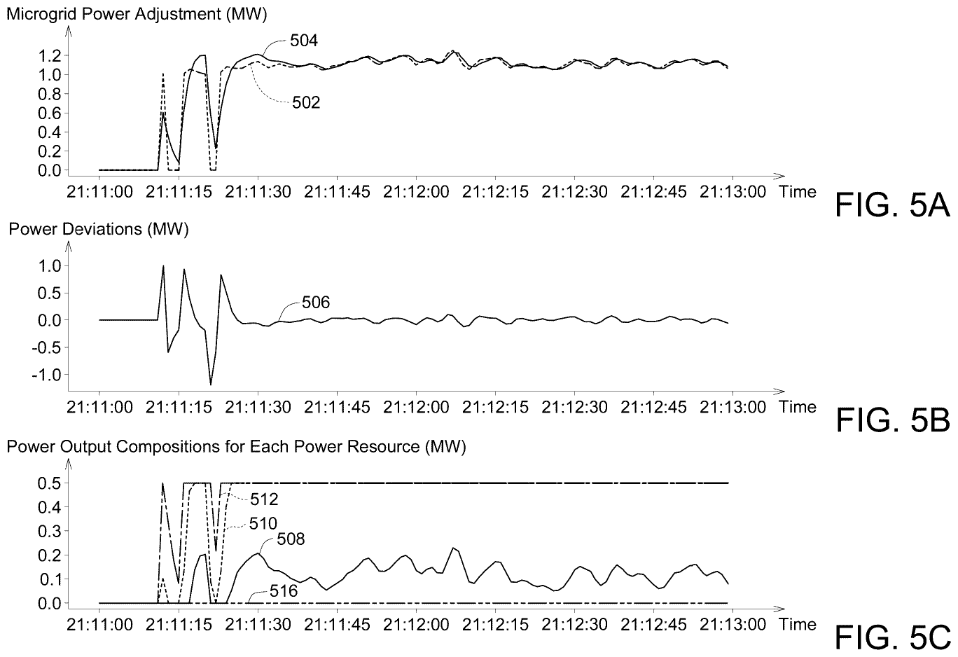

Refer to FIG. 5A to FIG. 5C, which shows an example for microgrid power control results including microgrid power adjustment, power deviations, and power output compositions for each power resource. FIG. 5A to FIG. 5C shows closed-loop microgrid power control under an AGC signal over a two-minute interval (for example, from 21:11:00 to 21:13:00 (hours:minutes:seconds)). In FIG. 5A, the curve 502 of the AGC signal (target) and the curve 504 of the actual net power show that the output rises rapidly, briefly overshoots, and then closely tracks the target with minimal steady-state error. In FIG. 5B, the curve 506 of the instantaneous control error shows power deviations and exhibits short initial spikes and quickly decays to near zero, indicating stable regulation. FIG. 5C shows the power output compositions for each power resource, and curves 508, 510, 512, and 516 correspond to a first generator (for example, a diesel generator), a second generator, a battery storage, and flexible load shedding, respectively. In FIG. 5C, the curve 512 shows that the battery storage provides the dominant fast response (holding near its upper limit). The curve 508 shows that the first generator ramps more slowly to refine tracking. The curve 510 shows that the second generator assists only during the transient. The curve 516 shows that the flexible load shedding remains inactive. The results demonstrate hierarchical coordination that achieves rapid convergence to the AGC signal (target) without curtailing loads.

The microgrid power management system configured to control a number of power resources to provide ancillary services to a utility grid by interactive feedback control and dynamic resource prioritization can be applied in any industrial context requiring grid stability, optimized resource utilization, and time-varying cost-effective energy management. Industries such as manufacturing, commercial real estate, and utility-scale energy operations can benefit from the system's ability to provide ancillary services efficiently while integrating power resources, such as distributed energy resources (DERs) like PV and BESS.

For manufacturing facilities with energy-intensive operations, the microgrid power management system can dynamically prioritize resource allocation to reduce peak demand charges and optimize energy use during low-cost periods. By coordinating DERs in real time, the microgrid power management system ensures uninterrupted operations while maintaining compliance with grid stability requirements. This application is particularly valuable for facilities participating in demand response programs, where fast, scalable responses to grid signals are essential.

The microgrid power management system's predictive analytics and optimization capabilities make it ideal for commercial real estate applications, such as smart buildings and campus environments. By adjusting energy demand and integrating user preferences, the microgrid power management system dynamically adjusts the operation of HVAC (Heating, Ventilation, and Air Conditioning) systems, lighting, and other controllable loads to balance comfort and energy costs. This leads to reduced utility bills and enhanced tenant satisfaction, making it a valuable tool for property management.

In utility-scale energy operations, the microgrid power management system provides a robust framework for integrating renewable energy sources into the utility grid. By prioritizing the use of PV and BESS, the microgrid power management system enhances grid reliability while reducing reliance on fossil fuels. This application is crucial for utilities aiming to meet renewable energy targets and maintain system stability under high renewable penetration.

Compared to existing methods, the disclosed system's integration of real-time control, dynamic prioritization, and predictive analytics ensures superior adaptability and scalability. Its ability to seamlessly manage multiple DERs in diverse industrial scenarios makes it a transformative tool for modern energy management. With its potential to reduce costs, enhance grid stability, and support renewable energy integration, this microgrid power management system represents a significant advancement in industrial energy solutions.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A microgrid power management system configured to control a plurality of power resources to provide ancillary services to an electrical power system, comprising:
a resource preference generating unit, for generating a plurality of priority parameters for the power resources based on a plurality of time-varying cost-effectiveness values of the power resources and an accumulated deviation value, wherein the accumulated deviation value is a sum of deviations between a target power setpoint and an actual power value over a time period, the target power setpoint is provided by the electrical power system, and the actual power value comprises a total power of the power resources; and
an adjustment command generating unit, for outputting a plurality of power control commands to the power resources according to the priority parameters for the power resources;
wherein at least one of the power resources adjusts power delivered to the electrical power system or at least one of the power resources adjusts power consumption from the electrical power system in response to at least one corresponding power control command.

2. The microgrid power management system according to claim 1, further comprising:
an economic parameter calculating unit, for receiving a price offer value from the electrical power system and outputting the price offer value to the resource preference generating unit, wherein the resource preference generating unit generates the priority parameters for the power resources according to the time-varying cost-effectiveness values of the power resources, the actual power value at a point of common coupling, the accumulated deviation value, and the price offer value, and the target power setpoint is included in an automatic generation control (AGC) signal outputted from the electrical power system.

3. The microgrid power management system according to claim 1, wherein the resource preference generating unit generates the priority parameters for the power resources according to the time-varying cost-effectiveness values of the power resources, the accumulated deviation value, and constraints of the power resources.

4. The microgrid power management system according to claim 3, wherein the constraints of the power resources comprise at least one of maximum output, ramp rate, state-of-charge limitations for the power resources being energy storage units.

5. The microgrid power management system according to claim 1, wherein the time-varying cost-effectiveness values of the power resources are determined according to unit power per cost of the power resources, and the unit power per cost of the power resources is determined according to electricity cost and wearing cost of the power resources.

6. The microgrid power management system according to claim 1, wherein the resource preference generating unit is implemented as a dynamic unit configured to generate, in real time, the priority parameters for the power resources.

7. The microgrid power management system according to claim 1, wherein the power resources comprises at least one flexible load device, at least one energy storage unit, and at least one local electricity generator, the at least one energy storage unit and the at least one local electricity generator adjust power delivered to the electrical power system in response to at least one corresponding power control command of the at least one energy storage unit and the at least one local electricity generator, and the at least one flexible load device adjust power consumption from the electrical power system in response to at least one power control command of the at least one flexible load device.

8. The microgrid power management system according to claim 1, wherein real-time data of the power resources is inputted to the resource preference generating unit, the priority parameters for the power resources are generated according to the time-varying cost-effectiveness values of the power resources, the accumulated deviation value, the constraints for the power resources, and real-time data of the power resources, and feedback control mechanism is performed to minimize deviations between the target power setpoint and the actual power value.

9. The microgrid power management system according to claim 1, wherein the ancillary services comprises at least one of frequency regulation and voltage control for the electrical power system.

10. The microgrid power management system according to claim 1, further comprising a deviation calculating unit and a deviation accumulating unit, the deviation calculating unit outputs the deviations between the target power setpoint and the actual power value, the deviation accumulating unit outputs the accumulated deviation value.

11. A microgrid power management method for controlling a plurality of power resources to provide ancillary services to an electrical power system, comprising:
generating a plurality of priority parameters for the power resources based on a plurality of time-varying cost-effectiveness values of the power resources and an accumulated deviation value, wherein the accumulated deviation value is a sum of deviations between a target power setpoint and an actual power value over a time period, the target power setpoint is provided by the electrical power system, and the actual power value comprises a total power of the power resources; and
outputting a plurality of power control commands to the power resources according to the priority parameters of the power resources;
wherein at least one of the power resources adjusts power delivered to the electrical power system or at least one of the power resources adjusts power consumption from the electrical power system in response to at least one corresponding power control command.

12. The microgrid power management method according to claim 11, further comprising:
receiving a price offer value from the electrical power system, wherein the priority parameters for the power resources are generated according to the time-varying cost-effectiveness values of the power resources, the actual power value at a point of common coupling, the accumulated deviation value, the price offer value, and the target power setpoint is included in an AGC signal outputted from the electrical power system.

13. The microgrid power management method according to claim 11, wherein the priority parameters for the power resources are generated according to the time-varying cost-effectiveness values of the power resources, the accumulated deviation value, and constraints of the power resources.

14. The microgrid power management method according to claim 13, wherein the constraints of the power resources comprise at least one of maximum output, ramp rate, state-of-charge limitations for the power resources being energy storage units.

15. The microgrid power management method according to claim 11, wherein the time-varying cost-effectiveness values of the power resources are determined according to unit power per cost of the power resources, and the unit power per cost of the power resources is determined according to electricity cost and wearing cost of the power resources.

16. The microgrid power management method according to claim 11, wherein the priority parameters for the power resources are generated in real time by a dynamic unit.

17. The microgrid power management method according to claim 11, wherein the power resources comprises at least one flexible load device, at least one energy storage unit, and at least one local electricity generator, the at least one energy storage unit and the at least one local electricity generator adjust power delivered to the electrical power system in response to at least one corresponding power control command of the at least one energy storage unit and the at least one local electricity generator, and the at least one flexible load device adjust power consumption from the electrical power system in response to at least one power control command of the at least one flexible load device.

18. The microgrid power management method according to claim 11, wherein the priority parameters for the power resources are generated using the time-varying cost-effectiveness values of the power resources, an accumulated deviation value, the constraints of the power resources, and real-time data of the power resources.

19. The microgrid power management method according to claim 11, wherein the ancillary services comprises at least one of frequency regulation and voltage control for the electrical power system.

20. The microgrid power management method according to claim 11, wherein feedback control mechanism is performed to minimize deviations between the target power setpoint and the actual power value.
